(19) United States
(12) Patent Application Publication
(10) Pub. No.: US 2013/0068560 A1
(43) Pub. Date: Mar. 21, 2013

(54) Extension Ladder Stabilizer And Stiffener

(71) Applicant: Charles E. Estep, Baltimore, MD (US)

(72) Inventor: Charles E. Estep, Baltimore, MD (US)

(21) Appl. No.: 13/233,237

(22) Filed: Sep. 15, 2011

(51) Int. Cl. E06C 7/10

(52) U.S. Cl. 182/107

(57) ABSTRACT

An improved device for stabilizing and stiffening an extension ladder includes a telescoping member with proximal and distal ends, a base that is attached to the proximal end of the telescoping member and has a configuration which is adapted to allow it to be adjustably affixed between the rungs of the ladder so that the angle between the centerline of the telescoping member and the plane defined by the extension ladder's rungs can be adjustably set so that the distal end of the telescoping member extends approximately horizontal to contact the vertical surface against which the extension ladder is leaning, and a transverse member that is attached to the telescoping member's distal end and has a configuration which is adapted to enhance the ability of the ladder to resist twisting about the centerline of the ladder.

### BACKGROUND OF THE INVENTION

1. Field of the Invention

The present invention relates generally to ladders. More particularly, the present invention relates to an improved means for stabilizing and stiffening a portable, extension ladder when it is placed against a wall or other vertical surface for use.

2. Description of the Related Art

Ladders today are of two general types, step ladders and extension ladders. Both of these employ portions that consist essentially of two long, parallel poles or vertical members between which extend a series of rungs having equivalent spacing along the poles. Step ladders which ordinarily fold have an A-shaped configuration with one side having such a series of rungs or steps. Extension ladders have two straight sections that are mounted in parallel adjacent planes in an overlapping relationship. The sections can be compressed for carrying and storage and extended to a desired length for use. Although the two sections usually are used together to provide a greater overall length than either section, they usually can be separated and used individually if desired.

While step ladders are self-supporting, extension ladders have to be placed against a vertical surface such as a wall of a building. The upper end of the ladder is placed in contact with the building and the bottom end or legs of the ladder rest on the ground a distance out from the building.

Extension ladders enable a person to reach a long distance above the ground with a structure that is relatively compact, but such ladders do have certain shortcomings. They are frequently difficult to handle and position when extended. Also, they have a very small horizontal dimension compared with their extended length. This makes them comparatively unstable, and as a result, many injuries are incurred each year due to people falling from extension ladders.

Some of these falls are the result of the ladder user reaching too far to the side of the ladder so the center of gravity of the ladder and its user shifts away from the vertical centerline of the ladder causing it to twist and potentially tip over. To overcome these problems, a number of ladder stabilizing devices have been proposed and patented. These often consist of some form of a pair of adjustable, telescoping arms, one of which extends from each pole of the ladder to a suitably chosen spot on the ground where it is anchored to enhance the ladder's resistance to twisting. Examples of such include U.S. Pat. Nos. 5,715,908, 5,868,222, 5,918,698, 6,527,084 and 7,216,742. None of these devices has gained wide acceptance over the years.

While tipping can occur when a ladder is placed on a firm level base, the chance of tipping is much greater when the ladder legs are placed on a base that slopes. Since a ladder is very long as compared with its width, any non-levelness or variation in the base surface on which the ladder rests is magnified in the sideways inclination of the ladder to the left or right of its base.

To maintain a ladder upright and its legs level under such conditions, its user ordinarily will place an object under the bottom of its legs. While this may level the ladder at that particular position, moving the ladder to another location, e.g. along a wall, may change the inclination of the base surface requiring that a number of objects of different thicknesses be available to provide the needed leveling. This can make the leveling time-consuming and frustrating as well as of questionable safety.

To overcome these leveling problems, a number of ladder leveling devices for attachment to the bottom of a ladder's poles or legs have been patented; see, for example, U.S. Pat. Nos. 4,069,893, 4,683,982, 5,341,899, 5,542,497, 5,704,451, 5,718,306, 5,853,065, 6,253,876 and 7,093,690.

When the sections of an extension ladder are appreciably extended, the ladder can often exhibit a noticeable lack of stiffness which its user feels as excessive bending and swaying about the union between the ladder's two sections. Until now, this problem seems not to have been addressed in the patent literature.

From the above discussion, it appears that the previous methods and devices for addressing the problems exhibited in the use of extension ladders have not proved totally satisfactory. Thus, there is a need for an improved means for enhancing an extension ladder's stability and its stiffness when in use.

### SUMMARY OF THE INVENTION

Recognizing the need for the development of an improved means for enhancing an extension ladder's stability and stiffness, the present invention is generally directed to overcoming the problems and disadvantages exhibited by prior, extension ladder stabilizing devices.

In accordance with a preferred embodiment of the present invention, a device for stabilizing and stiffening an extension ladder, whose upper end is leaning against an adjoining vertical surface, and which is of the type having a telescoping member with a distal end that has a configuration which is adapted to enhance the distal end's ability to be secured to a support surface, has the improvements of: (1) a base that is attached to the proximal end of the telescoping member and has a configuration that is adapted to allow this proximal end to be detachably and adjustably attached between the rungs of the extension ladder so that the angle between the centerline of the telescoping member and the plane defined by the extension ladder's rungs can be adjustably set so as to allow the telescoping member's distal end to be extended approximately horizontal so that it comes into contact with the vertical surface against which the extension ladder's upper end is leaning, and (2) a ladder width-increasing member that is attached to the telescoping member's distal end and has a configuration that is adapted to provide at least two, spaced-apart contact points for contacting the vertical surface against which the extension ladder's upper end is leaning in such a manner as to enhance the extension ladder's ability to resisting twisting about the ladder's bottom-to-top extending centerline and to resist movement towards the adjoining vertical surface of the point on the ladder where the device is attached to the ladder's rungs (thereby effectively stiffening the ladder).

Thus, there has been summarized above (rather broadly and understanding that there are other preferred embodiments which have not been summarized above) the present invention in order that the detailed description that follows may be better understood and appreciated.

### BRIEF DESCRIPTION OF THE DRAWINGS

FIG. 1 is a perspective view of a preferred embodiment of the present invention when it is in operation on an extension ladder that is leaning against an adjoining vertical wall.

FIG. 2 is a perspective view of a preferred embodiment of the present invention.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

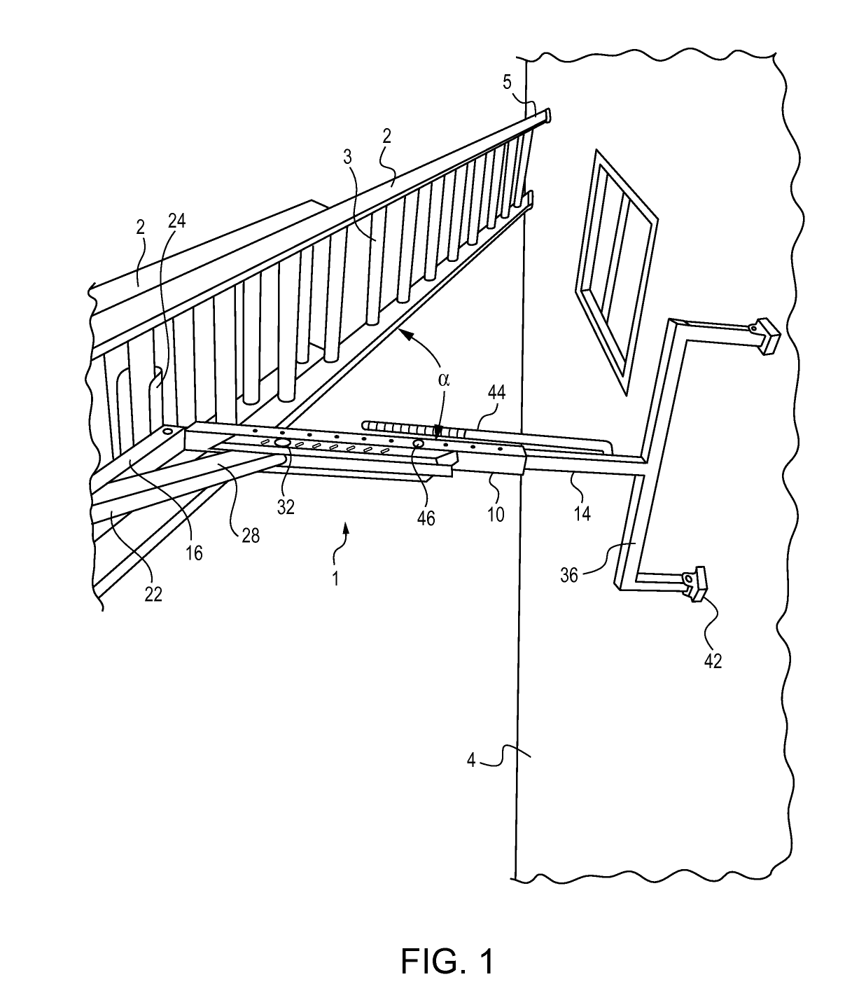

Referring to FIG. 1, there is illustrated a preferred embodiment of the present invention 1 in the form of an improved device for stabilizing and stiffening an extension ladder. Unlike prior devices for similar purposes, it is seen to be portable and for adjustable, attachable-detachable attachment on an extension ladder at point between its rungs that is generally located in the overlap region of the ladder's two sections.

The extension ladder shown in FIG. 1 is of the typical kind having a top and a bottom end and a centerline there-between and two straight sections, each of which consists of long, parallel poles or vertical members 2 between which extend a series of rungs 3 that are uniformly spaced along the poles. The sections are mounted in parallel, adjacent planes in an overlapping relationship and joined together in such a manner that the overlap region between the sections decreases as one of the sections is raised with respect to the bottom of the other section which sits on the ground adjoining a vertical surface 4 against which the upper end 5 of the raised section is leaned.

The device 1 includes a telescoping member 10 with proximal 12 and distal 14 ends. A base 16 is attached to the proximal end of the telescoping member 10 and has a configuration that is adapted to allow the proximal end to be detachably and adjustably attached between the rungs of the extension ladder in such a manner that the centerlines of the telescoping member and the extension ladder approximately intersect (i.e., depending upon how accurately the base is centered on a rung; note: this design feature proves to be important in order to allow the device to achieve its goal of minimizing twisting of the ladder about its centerline).

This base also allows the angle a between the end-to-end centerline of the telescoping member and the plane defined by the extension ladder's rungs to be adjustably set so that the telescoping member's distal end 14 can be approximately extended horizontally so that it comes into contact with the vertical surface against which the extension ladder's upper end is leaning and so that the centerline of the telescoping member is approximately perpendicular to the vertical wall.

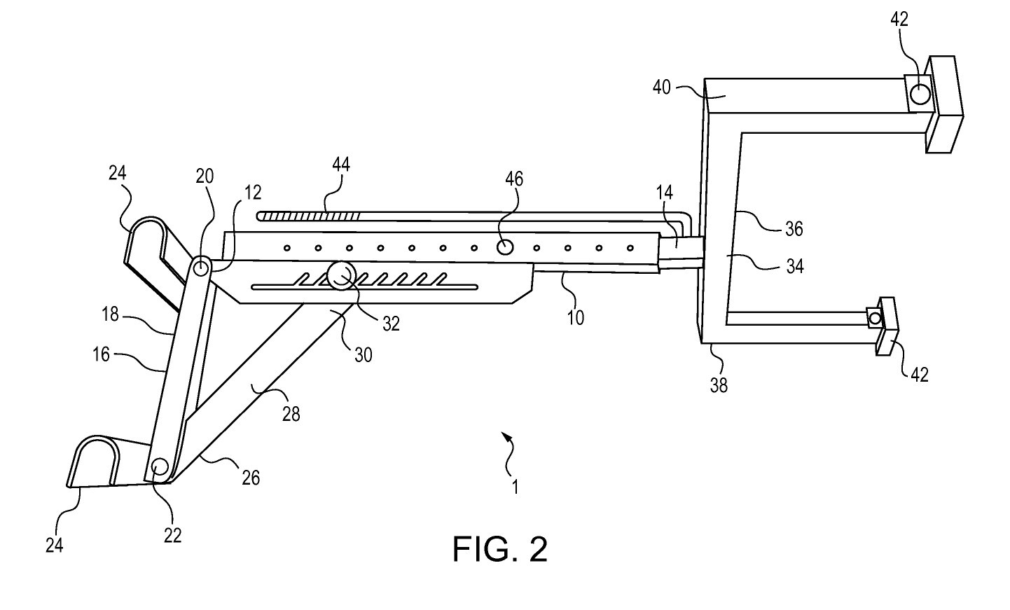

For the embodiment shown in FIG. 2, this base consists a first member 18 having top 20 and bottom 22 ends and a centerline between them. Attached to this member 18 are two spaced-apart brackets 24, each of which has a length which is just less than the spacing between the ladder's parallel poles and is further configured to be detachably affixed over the top of one of the ladder's rungs so as to effectively enclose a rung except for its bottom portion and so as to adjustably attach the device to the ladder at a height from ground which is chosen to allow the device 1 to be of maximum usefulness in its role of stabilizing and stiffening the ladder (i.e., at a point within the overlapping region of the sections of the ladder).

It should be noted that the brackets 24 have a length/width that is significantly wider than that of the telescoping member and that they are configured such that they provide outer contact points with the rung that are as far from the ladder's centerline as possible so as to provide an effective large lever arm to help in resisting a twisting motion of the ladder. In the embodiment shown in FIG. 2, the brackets 24 effectively enclose the top portion of a rung over practically its entire length (i.e., they enclose a large percentage of the surface area of a rung, 40-50%). This configuration or design feature of the brackets proves important in providing the present invention with its ability to aid the ladder in resisting twisting about its centerline. As a ladder start to twist, the outer edges of the rungs enclosed by the brackets move such that they come further into contact with their surrounding brackets and would cause these brackets to also move were it not for the fact that these brackets can resist movement since the telescoping member's distal end 14 effectively contacts the adjoining vertical wall with what I describe as a wide “footing/foot-print” which helps the brackets resist movement.

The telescoping member's proximal end 12 is pivotally connected to this first member near its top end 20 for the purpose of allowing the device to be folded together or collapsed so that it is of a more manageable size for transport and storage. Also pivotally attached near the first member's bottom end 22 is the proximal end 26 of a brace 28 whose distal end 30 is adjustably affixed by a quick-release mechanism 32 to the bottom portion of the telescoping member. It is this brace 28 which is adjustably used to set the orientation angle a of the telescoping member relative to the plane of the ladder and its rungs.

The mid-point 34 of a ladder width-increasing or traversing member 36 or means is attached to the telescoping member's distal end and has a configuration that is adapted to provide: (a) the previously described wide “footing/foot-print” for the telescoping member's distal end which helps the brackets 24 to resist movement and thereby enhance the ability of the ladder to resist twisting about its centerline, and (b) appropriately sized surface/s which will contact the adjoining vertical surface. The surface area of the surface/s must be sufficiently large so as to spread the load exerted by the device on the adjoining vertical surface so as to not damage or diminish the appearance of this vertical surface. Meanwhile the location of the surface/s relative to the centerline of the telescoping member must be such so as to provide resistance to the possible twisting of the ladder; this requirement will often result in the use of at least two, spaced-apart contact surfaces located at equivalent distances from and on each side of the telescoping member's centerline.

The traversing member 36 of this embodiment has two ends 38, 40, each of which has attached to it an adjustable mounted foot or pad 42 which is used to provide a reasonably sized surface area for contacting the adjoining vertical wall. The length between this traversing member's ends is chosen to be of sufficient magnitude so as to aid in enhance the extension ladder's ability to resisting twisting about the ladder's centerline (i.e., due to a user extending his center of gravity away from the ladder's centerline). The configuration and materials used for these pads will often be set by the requirement that their use with the device not damage or diminish the appearance of the adjoining vertical surface. An assortment of interchangeable pads can be made available to choose from to aid in ensuring that this no-damage requirement is met. Similarly, the configuration of the traversing member 36 can be chosen to allow for the variability that can be encountered in the geometries of the vertical surfaces against which the ladder is used (e.g., it may be a flat surface such as a brick wall or a round surface such as a circular building column).

To use the present invention, one attaches each of its brackets 24 over one of the ladder's rungs. The device's telescoping member 10 is then pivoted upwards about its proximal end from its storage or collapsed position adjacent the ladder's base 16 or first member and until the telescoping member assumes an approximately horizontal position. The base's brace 28, whose distal end was previously uncoupled via the quick—release mechanism from the telescoping member so that it could collapsed for storage or transport, is then pivoted upward about its proximal end so that its distal end can be adjustably affixed to the telescoping member to set or fix the telescoping member's horizontal orientation. The telescoping member's distal end is then adjustably extended using its extended handle 44 until the pads of its affixed traversing member contact the adjoining vertical surface against which the ladder is leaning. A locking mechanism 46 on the telescoping member is then used to fix this ladder-setup-determined-contact-with-the-adjoining-vertical—surface-required length between the telescoping member's ends. When it is time to take down the ladder, this locking mechanism is released so that the telescoping member can be adjusted to its minimum between-ends length for storage or transport of the device 1.

The foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that is hereinafter set forth in the claims to the invention.

I claim:

1. An improved device for stabilizing and stiffening an extension ladder, said extension ladder of the type having a top and a bottom end and a centerline therebetween and two sections, each of which have a pair of parallel, straight members between which extend a series of rungs, each of which has a specified length and a top portion of said rung, and the sections are oriented adjacent to each other and in an overlapping relationship and joined together in such a manner that the overlap region between the sections decreases as one of the sections is raised, and wherein the top end of said ladder is intended to be leaned by a ladder user against an adjoining vertical surface, wherein the improved device comprising:
a telescoping member with proximal and distal ends and a centerline extending between these ends,
a base that is attached to the proximal end of the telescoping member and has a configuration which is adapted: (a) to allow the telescoping member to be adjustably affixed to the ladder at a point within the overlapping region of the sections of the ladder and located such that the centerlines of the telescoping member and the extension ladder approximately intersect, and (b) so that the telescoping member can be oriented so that the distal end of the telescoping member extends approximately horizontal so as to perpendicularly contact the vertical surface against which the extension ladder is leaning, and
a transverse member that is attached to the distal end of the telescoping member and has a configuration which is adapted to enhance the ability of the ladder to resist twisting about the centerline of the ladder.

2. The improved device as recited in claim 1, wherein:
said base having a bracket that is configured to fit over said top portion of a rung and have a contact point with said rung on each side of said ladder centerline that is as far from the ladder centerline as possible.

3. The improved device as recited in claim 1, wherein:
said base having a first member and a brace,
said first member having top and bottom ends and wherein said first member top end is pivotably connected to the proximal end of said telescoping member, and
said brace having proximal and distal ends and wherein said brace proximal end is pivotably connected to the bottom end of said first member and said brace distal end is adjustably affixed at a point selected between said ends of said telescoping member so as to set the orientation angle of the centerline of said telescoping member relative to that of the centerline of ladder.

4. The improved device as recited in claim 2, wherein:
said base further having a first member and a brace,
said first member having top and bottom ends and wherein said first member top end is pivotably connected to the proximal end of said telescoping member, and
said brace having proximal and distal ends and wherein said brace proximal end is pivotably connected to the bottom end of said first member and said brace distal end is adjustably affixed at a point selected between said ends of said telescoping member so as to set the orientation angle of the centerline of said telescoping member relative to that of the centerline of ladder.

5. The improved device as recited in claim 4, wherein:
said bracket being a pair of brackets, one of which is connected proximate each of said top and bottom ends of said first member.

6. The improved device as recited in claim 2, wherein:
said transverse member having two ends and a midpoint between said ends and a specified separation distance between said ends, and said specified separation distance between said ends chosen so as to enhance the ability of the ladder to resist twisting about the centerline of the ladder.

7. The improved device as recited in claim 3, wherein:
said transverse member having two ends and a midpoint between said ends and a specified separation distance between said ends, and
said specified separation distance between said ends chosen so as to enhance the ability of the ladder to resist twisting about the centerline of the ladder.

8. The improved device as recited in claim 4, wherein:
said transverse member having two ends and a midpoint between said ends and a specified separation distance between said ends, and
said specified separation distance between said ends chosen so as to enhance the ability of the ladder to resist twisting about the centerline of the ladder.

9. The improved device as recited in claim 6, wherein:
said transverse member further having a pad attached each of said traverse member ends, and
said pads configured so as to spread the load exerted by the device on the adjoining vertical surface so as to not damage said vertical surface.

10. The improved device as recited in claim 8, wherein:
said transverse member further having a pad attached each of said traverse member ends, and
said pads configured so as to spread the load exerted by the device on the adjoining vertical surface so as to not damage said vertical surface.
